(19) United States
(12) Patent Application Publication
(10) Pub. No.: US 2024/0396465 A1
(43) Pub. Date: Nov. 28, 2024

(54) POWER CONVERSION DEVICE, MOTOR DRIVE DEVICE, AND REFRIGERATION-CYCLE APPLICATION APPARATUS

(71) Applicant: Mitsubishi Electric Corporation, Tokyo (JP)

(72) Inventors: Tomohiro KUTSUKI, Tokyo (JP); Koyo MATSUZAKI, Tokyo (JP); Koichi ARISAWA, Tokyo (JP); Takaaki TAKAHARA, Tokyo (JP); Haruka MATSUO, Tokyo (JP)

(21) Appl. No.: 18/687,036

(22) PCT Filed: Nov. 9, 2021
(86) PCT No.: PCT/JP2021/041193

§ 371 Date: Feb. 27, 2024

(51) Int. Cl. H02M 5/458; F25B 49/02; H02M 1/42; H02P 27/08

(52) U.S. Cl. CPC H02M 5/4585; H02M 1/4225; H02P 27/085; F25B 49/025; F25B 2600/021

(57) ABSTRACT

A power conversion device includes a converter that rectifies a first alternating-current power supplied from an alternating-current power supply and boosts a voltage of the power rectified; a smoothing unit connected to an output end of the converter; and a control unit that controls the converter to cause an input current to the converter to change in accordance with at least one of a first frequency or a second frequency, and that reduces a current flowing to the smoothing unit, the first frequency being a frequency of pulsation of input power to a load unit connected across the smoothing unit, the second frequency being a frequency of pulsation of input power to the converter due to a frequency of the alternating-current power supply.

### CROSS-REFERENCE TO RELATED APPLICATION

This application is a U.S. national stage application of PCT/JP2021/041193 filed on Nov. 9, 2021, the contents of which are incorporated herein by reference.

### FIELD

The present disclosure relates to a power conversion device that converts Alternating-Current (AC) power into desired power, to a motor drive device, and to a refrigeration-cycle application apparatus.

### BACKGROUND

A power conversion device that converts AC power into desired power is applied to, for example, an air conditioner. In a compressor such as a rotary compressor included in such an air conditioner, a load torque of a motor periodically varies in the course of fluid compression including a set of suction, compression, and discharge processes. Thus, if an output torque of the motor is kept constant, a rotational speed of the compressor varies and the compressor produces vibrations. In response to this problem, Patent Literature 1 discloses a power conversion device (converter) that performs torque control to vary an output torque in accordance with variations in a load torque that occurs in a single rotation of a motor of a compressor, thereby reducing vibrations of the compressor.

### PATENT LITERATURE

Patent Literature 1: Japanese Patent Application Laid-open No. H02-017884

However, in performing the control to vary an output torque in accordance with variations in a load torque, it is necessary to vary an input power to and an input current to an inverter that generates an output torque to the motor. Additionally, in varying the input power to and the input current to the inverter, a current flowing to a smoothing capacitor (hereinafter, such a current may be referred to as a capacitor current) increases in response to the variations in the input current. Here, the smoothing capacitor is provided at the preceding stage of the inverter in order to smooth a current output from a converter that rectifies AC power. In view of the increase in the capacitor current, it is necessary to select a capacitor having a current tolerance higher than that in a case where control to make the output torque of the motor constant is performed. That is, the capacitor needs to be increased in size, resulting in a problem of an increase in size of the power conversion device.

### SUMMARY

The present disclosure has been made in view of the circumstances, and an object of the present disclosure is to provide a power conversion device that can reduce an increase in size of an apparatus.

To solve the problem and achieve the object described above, a power conversion device according to the present disclosure comprises: a converter rectifying a first alternating-current power supplied from an alternating-current power supply and boosting a voltage of the first alternating-current power rectified; a smoothing unit connected to an output end of the converter; and a control unit controlling the converter to cause an input current to the converter to change in accordance with at least one of a first frequency or a second frequency, and reducing a current flowing to the smoothing unit, the first frequency being a frequency of pulsation of input power to a load unit connected across the smoothing unit, the second frequency being a frequency of pulsation of input power to the converter due to a frequency of the alternating-current power supply.

The power conversion device according to the present disclosure has an effect of capable of reducing the increase in size of the apparatus.

### BRIEF DESCRIPTION OF DRAWINGS

FIG. 1 is a diagram illustrating a schematic configuration of a power conversion system implemented by applying a power conversion device according to a first embodiment.

FIG. 2 is a diagram illustrating an exemplary configuration of the power conversion device according to the first embodiment.

FIG. 3 is a diagram illustrating an exemplary configuration of an inverter and a compressor.

FIG. 4 is a diagram illustrating, as a first comparative example of the first embodiment, an example of operation waveforms of the power conversion device in a case where constant torque control is performed.

FIG. 5 is a diagram illustrating, as a second comparative example of the first embodiment, an example of operation waveforms of the power conversion device in a case where vibration reduction control is performed.

FIG. 6 is a diagram illustrating an example of a control block constituting a control unit of the power conversion device according to the first embodiment.

FIG. 7 is a diagram for describing a current command in a case where control using the control block illustrated in FIG. 6 is applied.

FIG. 8 is a diagram illustrating, as a comparative example, an example of operation waveforms of the respective constituent components in a case where the power conversion device drives a motor of the compressor using the vibration reduction control and general high power factor control.

FIG. 9 is a diagram illustrating an example of operation waveforms of the respective constituent components in a case where the power conversion device drives the motor of the compressor using the vibration reduction control and capacitor current reduction control.

FIG. 10 is a diagram illustrating an example of a control block constituting a control unit of a power conversion device according to a second embodiment.

FIG. 11 is a diagram illustrating an example of operation waveforms of the power conversion device according to the second embodiment.

FIG. 12 is a diagram illustrating a frequency analysis result of a converter input power illustrated in FIG. 11.

FIG. 13 is a diagram illustrating, as a comparative example, an example of operation waveforms of the respective constituent components in a case where the power conversion device according to the second embodiment drives a motor of a compressor using the general high power factor control.

FIG. 14 is a diagram illustrating an example of operation waveforms of the respective constituent components in a case where the power conversion device according to the second embodiment drives the motor of the compressor using the capacitor current reduction control.

FIG. 15 is a diagram illustrating, as a first comparative example of a third embodiment, an example of operation waveforms in a case where the high power factor control and the vibration reduction control are performed in combination.

FIG. 16 is a diagram illustrating, as a second comparative example of the third embodiment, an example of operation waveforms in a case where the high power factor control, the vibration reduction control, and inverter current pulsation control are performed in combination.

FIG. 17 is a diagram illustrating an example of operation waveforms in a case where the control according to the third embodiment is performed.

FIG. 18 is a diagram for describing an operation of a power conversion device according to a fourth embodiment.

FIG. 19 is a diagram illustrating a first exemplary configuration of a power conversion device according to a fifth embodiment.

FIG. 20 is a diagram illustrating a second exemplary configuration of the power conversion device according to the fifth embodiment.

FIG. 21 is a diagram illustrating a third exemplary configuration of the power conversion device according to the fifth embodiment.

FIG. 22 is a diagram illustrating an example of a hardware configuration that implements the control unit included in the power conversion device.

FIG. 23 is a diagram illustrating an exemplary configuration of a refrigeration-cycle application apparatus according to a sixth embodiment.

### DETAILED DESCRIPTION

Hereinafter, with reference to the drawings, a description will be given in detail of a power conversion device, a motor drive device, and a refrigeration-cycle application apparatus according to embodiments of the present disclosure.

### First Embodiment

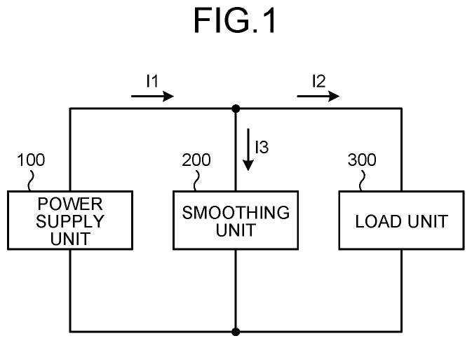

FIG. 1 is a diagram illustrating a schematic configuration of a power conversion system implemented by applying a power conversion device according to a first embodiment. As illustrated in FIG. 1, the power conversion system according to the first embodiment includes a power supply unit 100, a smoothing unit 200, and a load unit 300. The power supply unit 100 includes a commercial power supply, a rectifier circuit, and the like. The smoothing unit 200 includes a smoothing element such as an electrolytic capacitor. The load unit 300 includes a motor, an inverter that drives the motor, and the like.

In the power supply unit 100, AC power supplied from an AC power supply such as a commercial power supply is rectified by the rectifier circuit. The rectified power is output to the smoothing unit 200. The smoothing unit 200 smooths Direct-Current (DC) power that is the rectified power output from power supply unit 100. The smoothed DC power is output to the load unit 300 and consumed by the motor constituting the load unit 300.

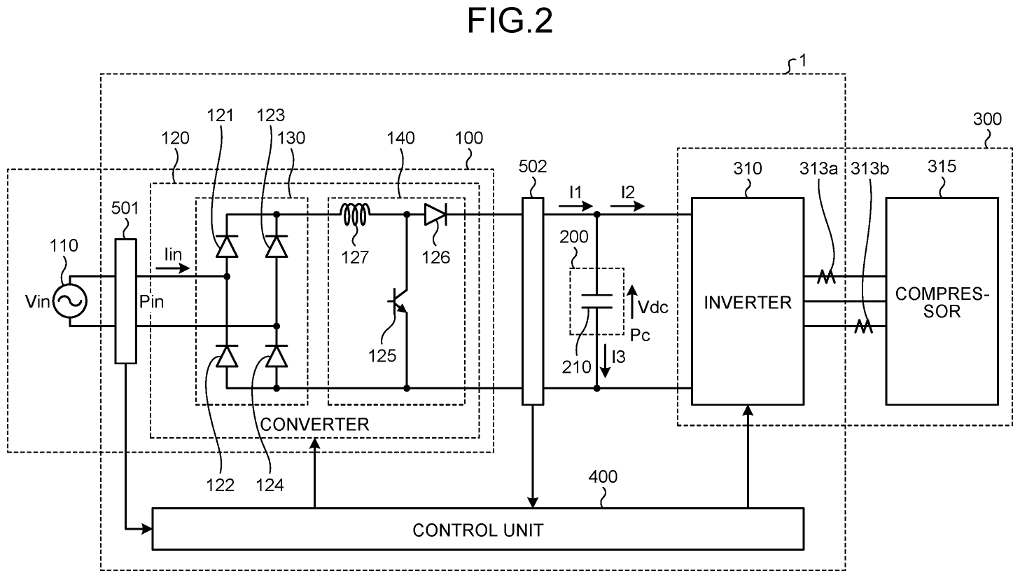

FIG. 2 is a diagram illustrating an exemplary configuration of a power conversion device 1 according to the first embodiment. The power conversion device 1 is connected to an AC power supply 110 such as a commercial power supply and to a compressor 315. The power conversion device 1 converts first AC power supplied from the AC power supply 110 into second AC power having a desired amplitude and a desired phase, and supplies the second AC power to the compressor 315. The compressor 315 is, for example, a hermetic compressor to be applied to an air conditioner, and has the motor installed therein. That is, the power conversion device 1 constitutes a motor drive device that supplies the second AC power to the motor included in the compressor 315 to drive the motor.

The power conversion device 1 includes a voltage-current detector 501, a converter 120, a voltage detector 502, the smoothing unit 200, an inverter 310, and a control unit 400. Note that, the converter 120 and the AC power supply 110 constitute the power supply unit 100 of the power conversion system illustrated in FIG. 1, and the inverter 310 and the compressor 315 constitute the load unit 300 of the power conversion system illustrated in FIG. 1. Additionally, one or both of the voltage-current detector 501 and the voltage detector 502 may be included in the converter 120.

The converter 120 is connected to the AC power supply 110. The converter 120 includes rectifiers 121 to 124, a switching element 125, a rectifier 126, and a reactor 127. The rectifiers 121 to 124 perform full-wave rectification of a power supply voltage supplied from the AC power supply 110. The switching element 125 is provided for boosting the full-wave rectified voltage. That is, the converter 120 rectifies the first AC power supplied from the AC power supply 110 and boosts the voltage of the rectified power. The rectifiers 121 to 124 constitute a rectifier circuit 130. The switching element 125, the rectifier 126, and the reactor 127 constitute a booster circuit 140. In the booster circuit 140, the switching element 125 is controlled by the control unit 400 to be turned on or off, thereby boosting the voltage that has been rectified by the rectifier circuit 130.

The smoothing unit 200 includes a smoothing capacitor 210. The smoothing capacitor 210 is connected to an output end of the converter 120. The smoothing unit 200 smooths DC power and supplies, as the smoothed power, the DC power to the inverter 310. The DC power is generated by the converter 120 executing a process of converting the power supply voltage from AC to DC.

The voltage-current detector 501 is provided between the AC power supply 110 and the converter 120, detects a voltage value and a current value of the first AC power supplied from the AC power supply 110 to the converter 120, and outputs the detected voltage value and current value to the control unit 400. In the present embodiment, the voltage value and the current value, which are detected by the voltage-current detector 501, are Vin and Iin, respectively.

Note that, although the present embodiment has described the configuration in which the voltage-current detector 501 is provided between the AC power supply 110 and the converter 120, the position where the current is detected is not limited to this configuration. A configuration may be adopted in which a current detector that detects the current flowing to the reactor 127 is provided, and a detection value of the current flowing to the reactor 127 is output to the control unit 400.

The voltage detector 502 is provided between the converter 120 and the smoothing unit 200, detects a voltage value of DC power supplied from the converter 120 to the inverter 310, and outputs the detected voltage value to the control unit 400. In the present embodiment, the voltage value detected by the voltage detector 502 is Vdc.

Note that in the following description, as illustrated in FIG. 2, a current flowing from the converter 120 to the smoothing unit 200 and the inverter 310 is referred to as a current I1, a current flowing to the inverter 310 is referred to as a current I2, and a capacitor current that is a current flowing to the smoothing capacitor 210 is referred to as a current I3. The currents I1 to I3 are regarded as positive when the currents I1 to I3 flow in respective corresponding directions indicated by arrows illustrated in FIG. 2.

The inverter 310 is connected across the smoothing unit 200, that is, the smoothing capacitor 210. The inverter 310 converts the smoothed DC power supplied from the smoothing unit 200 into second AC power and supplies the second AC power to the compressor 315.

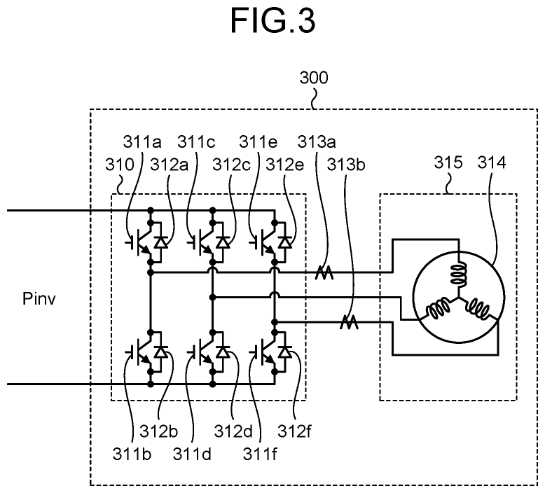

An exemplary configuration of the inverter 310 and the compressor 315 will be described. FIG. 3 is a diagram illustrating the exemplary configuration of the inverter 310 and the compressor 315.

As illustrated in FIG. 3, the inverter 310 includes switching elements 311a to 311f and freewheeling diodes 312a to 312f each connected in parallel with any corresponding one of the switching elements 311a to 311f. The compressor 315 is a load having a motor 314 for driving the compressor. Current detectors 313a and 313b are provided between the inverter 310 and the motor 314.

The inverter 310 turns on and off the switching elements 311a to 311f under the control of the control unit 400, and converts power Pinv received from the converter 120 and the smoothing unit 200 into the second AC power having a desired amplitude and a desired phase. The current detectors 313a and 313b each detect a current value of a corresponding one phase among the currents of the three phases output from the inverter 310, and output the detected current value to the control unit 400. Note that, the control unit 400 can calculate the current value of the remaining one phase output from the inverter 310 by acquiring the current values of two phases among the current values of three phases output from the inverter 310. The motor 314 of the compressor 315 rotates in accordance with the amplitude and the phase of the second AC power supplied from the inverter 310, thus performing a compression operation. For example, in a case where the compressor 315 is a hermetic compressor for use in an air conditioner or the like, the load torque of the compressor 315 can be considered as a constant torque load in many cases.

Returning to the description of FIG. 2, the control unit 400 acquires, from the voltage-current detector 501, the voltage value Vin and the current value Iin of the first AC power that are input to the converter 120, acquires, from the voltage detector 502, the voltage value Vdc of the DC power that is output from the converter 120, and acquires, from the current detectors 313a and 313b, the current values of the second AC power that are output from the inverter 310 to the compressor 315. The control unit 400 controls the operation of the converter 120, specifically, the on and off states of the switching element 125 included in the booster circuit 140 of the converter 120, using the detection value detected by each of the voltage-current detector 501, the voltage detector 502, and the current detectors 313a and 313b. Additionally, the control unit 400 controls the operation of the inverter 310, specifically, the on and off states of the switching elements 311a to 311f included in the inverter 310, using the detection value detected by each of the voltage-current detector 501, the voltage detector 502, and the current detectors 313a and 313b. At this time, the control unit 400 controls the on and off states of the switching elements 311a to 311f so as to reduce the vibrations of the compressor 315. For example, similarly to the conventional power conversion device disclosed in Patent Literature 1, the control unit 400 controls the on and off states of the switching elements 311a to 311f such that the output torque changes in accordance with the variations in the load torque. Hereinafter, this control is referred to as vibration reduction control.

As described above, in performing the vibration reduction control, the current I2 flowing to the inverter 310 needs to be varied, resulting in a problem of an increase in the capacitor current (current I3) flowing to the smoothing capacitor 210 in response to the variations in the current I2. In view of this, the control unit 400 applies control different from the conventional control to the control for the converter 120, thereby reducing the capacitor current. Specifically, the control unit 400 controls the switching element 125 included in the converter 120, thus allowing input power Pin to the converter 120 (hereinafter, such input power Pin may be referred to as converter input power Pin) to be changed in accordance with the rotational speed of the motor 314 included in the compressor 315. Thus, the control unit 400 reduces the capacitor current flowing to the smoothing capacitor 210. Hereinafter, the control to change the input power Pin to the converter 120 in accordance with the rotational speed of the motor 314 performed by the control unit 400 in order to reduce the capacitor current may be referred to as capacitor current reduction control.

Here, a description will be given of, as a comparative example, an operation in a case where the control unit 400 does not perform the control to change the input power Pin to the converter 120 in accordance with the rotational speed of the motor 314. Specifically, a description will be given of a first comparative example and a second comparative example. The first comparative example represents an operation in a case where constant torque control, which is the control to make the output torque of the motor 314 included in the compressor 315 constant, is performed. The second comparative example represents an operation in a case where the above-described vibration reduction control is performed.

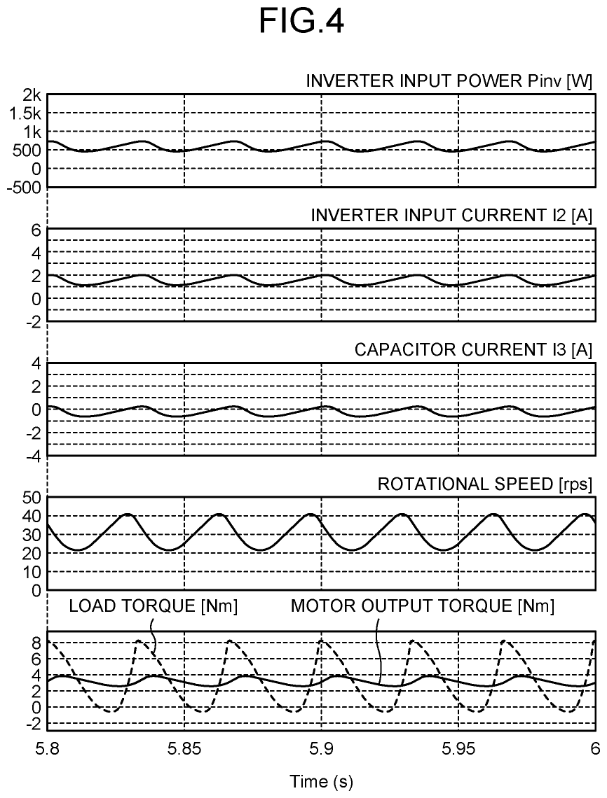

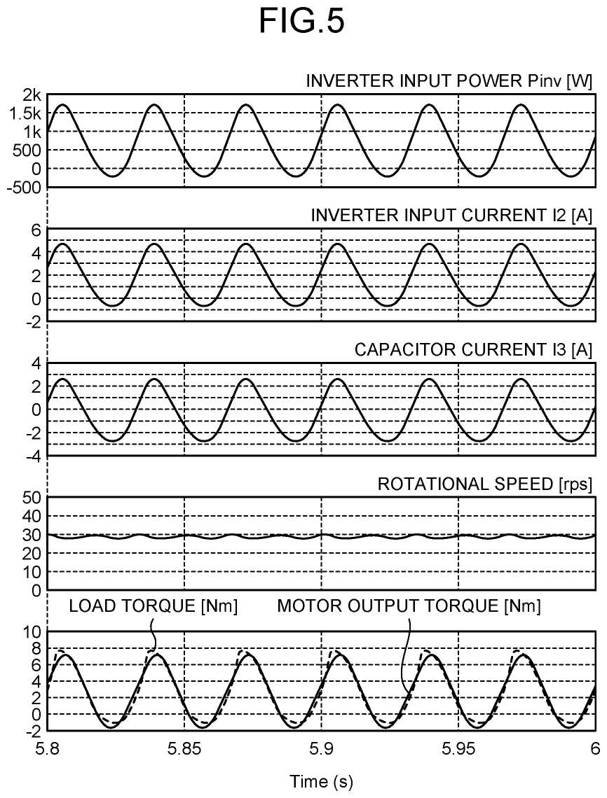

FIG. 4 is a diagram illustrating, as the first comparative example of the first embodiment, an example of operation waveforms of the power conversion device in the case where the constant torque control is performed. FIG. 5 is a diagram illustrating, as the second comparative example of the first embodiment, an example of operation waveforms of the power conversion device in the case where the vibration reduction control is performed. FIGS. 4 and 5 each illustrate the respective waveforms, in the order from top to bottom, of the input power Pinv to the inverter 310 (hereinafter, such input power Pinv may be referred to as inverter input power Pinv), the input current I2 to the inverter 310 (hereinafter, such an input current I2 may be referred to as an inverter input current I2), the current I3 flowing to the smoothing capacitor 210 (hereinafter, such a current I3 may be referred to as a capacitor current I3), the rotational speed of the motor 314, the load torque, and the output torque of the motor 314 (hereinafter, such an output torque may be referred to as a motor output torque). Since the inverter 310 constitutes the load unit 300, the inverter input power Pinv is also input power to the load unit 300. Note that in FIGS. 4 and 5, the illustration of current pulsation components due to the converter 120 is omitted from the capacitor current I3 in order to improve viewability of the increase in the capacitor current I3 caused by the performing of the vibration reduction control. Additionally, the illustration of pulsation components due to a switching frequency of the inverter 310 is also omitted.

According to the comparison of the respective waveforms illustrated in FIGS. 4 and 5, the performing of the vibration reduction control, that is, as illustrated in FIG. 5, the performing of control to vary the motor output torque in synchronization with the variations in the load torque achieves a reduction in the variations in the rotational speed of the motor 314. Thus, it can be said that the vibrations of the compressor 315 are reduced. However, in performing the vibration reduction control, in order to vary the load torque, it is necessary to cause the inverter input power Pinv and the inverter input current I2 to pulsate similarly to the motor output torque. This causes an increase in the capacitor current I3.

On the other hand, in the present embodiment, as described above, the control unit 400 performs the capacitor current reduction control to change the input power Pin to the converter 120 in accordance with the rotational speed of the motor 314. More specifically, the control unit 400 detects pulsation of the inverter input power Pinv due to the vibration reduction control or the like, and causes the input power Pin to the converter to pulsate at a frequency same as a first frequency that is the frequency of the detected pulsation. This achieves the reduction in the capacitor current I3 flowing to the smoothing capacitor 210 of the smoothing unit 200. Note that, since the pulsation of the inverter input power Pinv is due to the rotation of the motor 314, the first frequency that is the frequency of the pulsation of the inverter input power Pinv corresponds to the rotational speed of the motor 314.

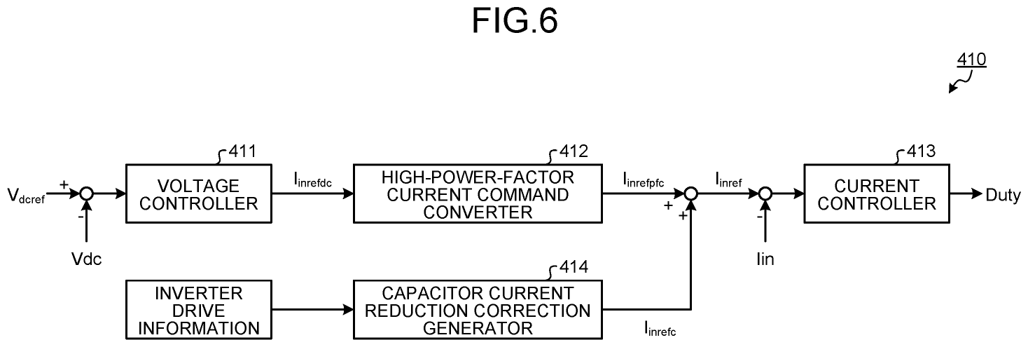

FIG. 6 is a diagram illustrating an example of a control block constituting the control unit 400 of the power conversion device 1 according to the first embodiment. A control block 410 illustrated in FIG. 6 is provided to generate a control signal for the converter 120, and implements the capacitor current reduction control.

The control block 410 includes a voltage controller 411, a high-power-factor current command converter 412, a current controller 413, and a capacitor current reduction correction generator 414. Note that, the control block in a case of implementing a converter that performs the general high power factor control does not include the capacitor current reduction correction generator 414. That is, the capacitor current reduction control implemented by the control block 410 is control to reduce the capacitor current while performing the high power factor control, and is a type of high power factor control.

The voltage controller 411 illustrated in FIG. 6 performs a control operation such that a DC voltage Vdc follows a DC voltage command V_{dcref} that is a command for the voltage controller 411. The current controller 413 illustrated in FIG. 6 performs a control operation such that a converter input current Iin follows a converter input current command I_{inref} that is a command for the current controller 413. The DC voltage Vdc is a DC voltage supplied from the converter 120 to the inverter 310 via the smoothing unit 200, and this voltage may be referred to as a capacitor voltage in the following description. The converter input current Iin is an AC current supplied from the AC power supply 110 to the converter 120. The voltage controller 411 and the current controller 413 each perform the above-described control operation using, for example, Proportional Integral Differential (PID) control, Proportional Integral (PI) control, Proportional (P) control, and the like. Note that, the control block 410 illustrated in FIG. 6 is configured to perform feedback control using the command value and the detection value. However, a part or all of the control block 410 may be configured to perform feedforward control by obtaining in advance a control amount that achieves a desired current and a desired voltage.

The capacitor current reduction correction generator 414 generates a current command I_{inrefc} that is a correction command for the current command value I_{inrefpfc} generated by the high-power-factor current command converter 412.

A description will be given of a method of deriving the current command I_{inrefc} output from the capacitor current reduction correction generator 414. The input power in a case where the converter circuit performs only the high power factor control is expressed by Formula (1).

$$Formula 1$$

$$Pin = {I}_{s} sin {ω}_{in} {tV}_{s} sin {ω}_{in} t \qquad ( 1 )$$

In Formula (1), Iₛ is the maximum value of the input current Iin to the converter 120, and Vₛ is the maximum value of the voltage Vin supplied from the AC power supply 110. Additionally, ωᵢₙ is a frequency of the AC power supply 110 (hereinafter, such a frequency is referred to as an AC power supply frequency). Note that, when the converter 120 can be controlled such that the output power of the converter 120 is provided at a desired current and a desired voltage in a steady state, the output I_{inrefpfc} of the high-power-factor current command converter 412 in FIG. 6 is the same as Iₛ sin ωᵢₙt in Formula (1).

In the case of the control block 410 in FIG. 6, the input power Pin to the converter 120 is expressed by Formula (2).

$$Formula 2$$

$$\begin{matrix}Pin = ( {I}_{s} sin {ω}_{in} t + {I}_{inrefc} ) {V}_{s} sin {ω}_{in} t \\ = \frac{{V}_{s} {I}_{s}}{2} - \frac{{V}_{s} {I}_{s}}{2} cos 2 {ω}_{in} t + {I}_{inrefc} {V}_{s} sin {ω}_{in} t\end{matrix} \qquad ( 2 )$$

The respective terms on the right side of Formula (2) represent, in the order from left to right, a DC component, pulsation of a frequency component twice the AC power supply frequency ωᵢₙ, and the product of the current command I_{inrefc} that is the correction command and Vₛ sin ωᵢₙt that is the voltage Vin supplied from the AC power supply.

Next, when the inverter input power Pinv is separated into a DC component P_{DC} and a pulsation component Pₘ due to the vibration reduction control, the inverter input power Pinv can be expressed by Formula (3).

$$Formula 3$$

$$Pinv = {P}_{DC} + {P}_{m} sin {ω}_{m} t \qquad ( 3 )$$

The pulsation of the actual load torque includes, as illustrated in FIG. 5, not only a single sine wave but also a high-order component, and the torque control is not performed using a single sine wave even in the vibration reduction control. However, in order to simplify the derivation, and since most of the components are composed of the fundamental wave components, only the fundamental wave frequency ωₘ component is used for expression in Formula (3). Note that, the fundamental wave frequency ωₘ can be considered as being the same as the rotational speed fm of the motor 314.

In order to reduce the current flowing to the smoothing unit 200 in performing the vibration reduction control, the converter input power Pin is only required to be caused to pulsate similarly to the inverter input power Pinv. That is, from Formula (2) and Formula (3), the current command I_{inrefc} generated by the capacitor current reduction correction generator 414 may be expressed by Formula (4).

$$Formula 4$$

$${I}_{inrefc} = \frac{{P}_{m}}{{V}_{s}} \frac{sin {ω}_{m} t}{sin {ω}_{s} t} \qquad ( 4 )$$

In Formula (4), the pulsation of the input power (the second term from the left on the right side of Formula (2)) due to the control for the converter 120 (hereinafter, such control may be referred to as converter control) is not canceled, and only the pulsation of the inverter input current is canceled.

Here, as can be seen from Formula (4), I_{inrefc} includes the AC power supply voltage in the denominator. Thus, when the input voltage to the converter 120 is close to zero crossing, the denominator becomes infinitely small, and the value to be corrected becomes large. Thus, there are concerns about deterioration of the power factor, an increase in harmonics of the AC power supply current, and an increase in loss of the converter 120. In view of this, the capacitor current reduction correction generator 414 obtains I_{inrefc} by changing a calculation method, instead of calculating I_{inrefc} using Formula (4) without change. For example, in a state where the absolute value of the denominator in Formula (4) is equal to or less than a predetermined threshold value, I_{inrefc} is calculated using the threshold value instead of the AC power supply voltage.

As illustrated in FIG. 6, information on the numerator in Formula (4) is obtained from inverter drive information that is drive information related to the inverter 310. For example, a method to be used may be a method of obtaining information on the numerator in Formula (4) using the input current I2 to and the DC voltage Vdc to the inverter 310 as the inverter drive information.

The current controller 413 adjusts a duty ratio Duty in turning on and off the switching element 125 such that the converter input current Iin approximates the converter input current command I_{inref}.

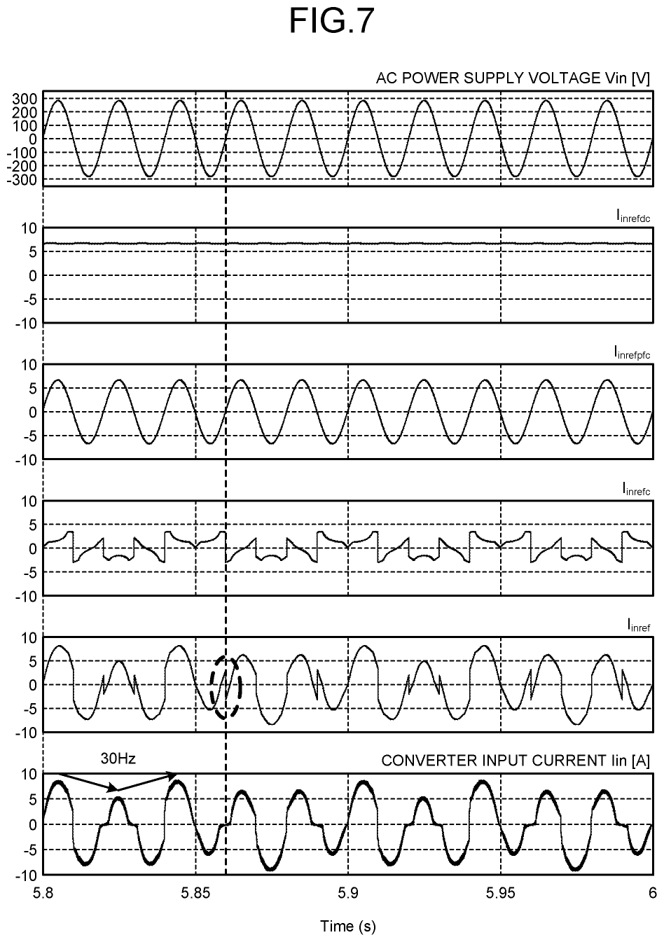

FIG. 7 is a diagram for describing a current command in the case where the control using the control block 410 illustrated in FIG. 6 is applied. FIG. 7 illustrates the respective waveforms, in the order from top to bottom, of the AC power supply voltage Vin input to the converter 120, I_{inrefdc} generated by the voltage controller 411, I_{inrefpfc} generated by the high-power-factor current command converter 412, the I_{inrefc} generated by the capacitor current reduction correction generator 414, the converter input current command I_{inref} that is a command for the converter input current Iin, and the converter input current Iin. The power pulsation of the load is 30 Hz.

The I_{inrefc} illustrated in FIG. 7 is derived using Formula (4). In order to prevent an excessive current flow, the capacitor current reduction correction generator 414 derives I_{inrefc} such that 150 V is fixed when the absolute value of the denominator in Formula (4) is equal to or less than 150 V.

As illustrated in FIG. 6, the command I_{inrefpfc} output from the high-power-factor current command converter 412 and the command I_{inrefc} output from the capacitor current reduction correction generator 414 are added together to generate the converter input current command I_{inref}. Here, as can be seen from a portion surrounded by a dotted line circle in FIG. 7, the polarities (plus and minus) of the AC power supply voltage Vin and the converter input current command I_{inref} are different. Since the current in this portion cannot be made to follow the converter input current command I_{inref} in terms of the circuit configuration, the converter input current command I_{inref} is zero in this portion. Note that, the operation of causing the switching element 125 to be switched may be stopped instead of setting the converter input current command I_{inref} to zero. It can be confirmed from the converter input current Iin illustrated in FIG. 7 that the input current pulsates at 30 Hz.

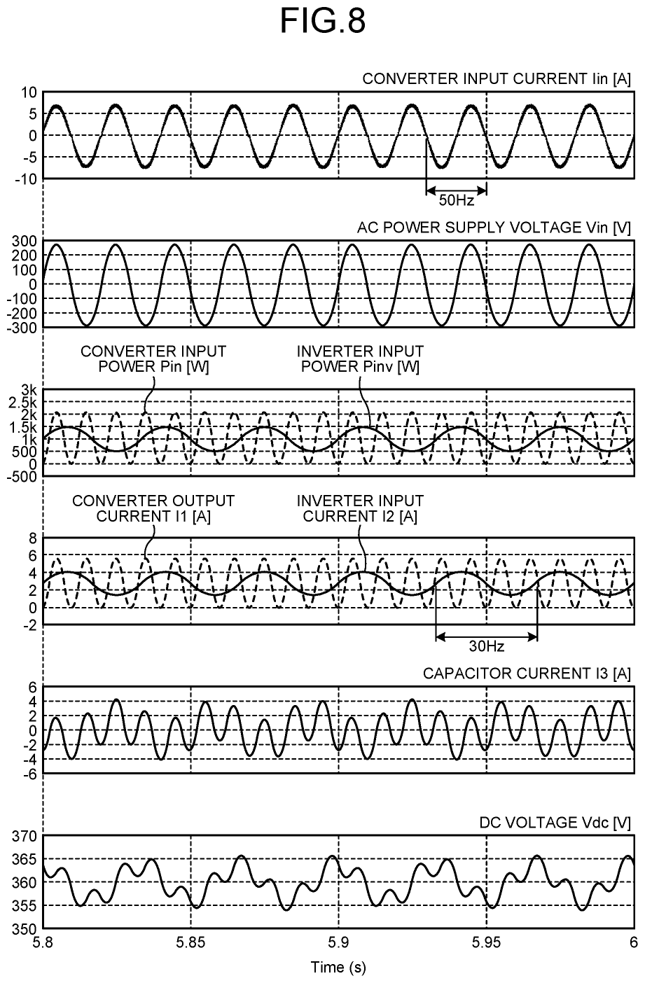

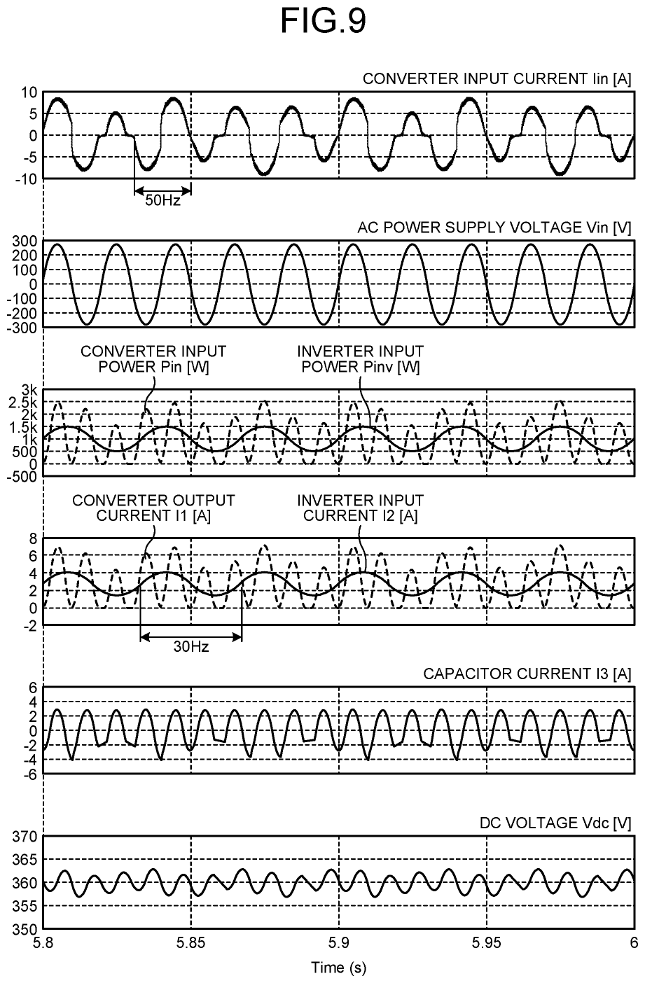

FIG. 8 is a diagram illustrating, as a comparative example, an example of operation waveforms (power waveform, current waveform, voltage waveform) of the respective constituent components in a case where the power conversion device 1 drives the motor 314 of the compressor 315 using the vibration reduction control and the general high power factor control. Additionally, FIG. 9 is a diagram illustrating an example of operation waveforms (power waveform, current waveform, voltage waveform) of the respective constituent components in a case where the power conversion device 1 drives the motor 314 of the compressor 315 using the vibration reduction control and the capacitor current reduction control. The operation waveforms illustrated in FIG. 9 are operation waveforms in a case where the current command illustrated in FIG. 7 is generated to control the converter 120.

FIGS. 8 and 9 each illustrate the respective waveforms, in the order from top to bottom, of the converter input current Iin, the AC power supply voltage Vin, the converter input power Pin and the inverter input power Pinv, the converter output current I1 and the inverter input current I2, the capacitor current I3, and the DC voltage Vdc. The illustration of pulsations of the converter output current I1 and the capacitor current I3 due to the switching frequency is omitted. The inverter 310 and the motor 314 are simulated by a variable power load, only the fundamental wave component is used for the pulsation component similarly to Formula (3) above, P_{DC} is 1 kW, Pₘ is 500 W, and frequency ωₘ is 30 Hz. Additionally, the maximum value Vₛ of the AC power supply voltage Vin is 200√2 V, and the AC power supply frequency ωᵢₙ is 50 Hz. The DC voltage command V_{dcref} input to the control block 410 illustrated in FIG. 6 is 360 V.

By applying the capacitor current reduction control implemented by the control block 410 illustrated in FIG. 6, the converter input power Pin varies in accordance with the pulsation of the inverter input power Pinv as illustrated in FIG. 9. As a result, the capacitor current I3 is reduced from 2.27 A to 2.05 A as compared with the case in FIG. 8 to which the capacitor current reduction control is not applied. Additionally, a ripple voltage of the DC voltage Vdc is also reduced.

As described above, the power conversion device 1 according to the first embodiment changes the converter input current Iin in accordance with the rotational speed of the motor 314 constituting the compressor 315 that is a connected load, more specifically, in accordance with the first frequency that is the frequency of the pulsation of the inverter input power Pinv that can be considered as the rotational speed of the motor 314, and causes the converter input power Pin to pulsate. The power conversion device 1 according to the first embodiment can reduce the capacitor current I3 flowing to the smoothing unit 200, thus making it possible to use, as the smoothing capacitor 210, a capacitor having a lower ripple current tolerance, and to achieve cost reduction. Furthermore, the pulsation voltage of the DC voltage Vdc decreases, thus making it possible to achieve a reduction in the capacitance of the smoothing capacitor 210 constituting the smoothing unit 200, that is, size reduction of the smoothing capacitor 210, and reduce the increase in size of the apparatus. For example, in a case where the capacitor current reduction control is applied to a power conversion device in which a smoothing unit that smooths a rectified DC voltage includes a plurality of capacitors, the current flowing to the smoothing unit is reduced, thus making it possible to reduce the number of capacitors constituting the smoothing unit and achieve size reduction of the apparatus.

A description will now be given of a current sensor that detects a current value used in the control for the converter 120.

In a case of a power conversion device having a converter to which the general high power factor control is applied instead of the capacitor current reduction control described above, the current sensor used for current detection needs to satisfy the relationship expressed by Formula (5):

$$fin > fisen \qquad ( 5 )$$

where fin represents the AC power supply frequency and fisen represents a lower limit frequency of the current observable by the current sensor.

However, in the power conversion device 1 according to the first embodiment to which the capacitor current reduction control is applied, there is a concern that when a lower limit frequency (lower limit rotational speed) fmin of the motor 314 is lower than an AC power supply frequency fin, the current is unobservable in a case of using the current sensor satisfying Formula (5) and the capacitor current reduction control cannot be performed. In view of this, in the case where the capacitor current reduction control is applied, the converter input current Iin is detected using a current sensor in which the observable lower limit frequency fisen satisfies the relationship expressed by Formula (6). That is, the voltage-current detector 501 is configured using the current sensor in which the observable lower limit frequency fisen satisfies the relationship expressed by Formula (6):

$$f min > fisen . \qquad ( 6 )$$

With the configuration in which the current value for use in the control for the converter 120 is detected by the current sensor satisfying the relationship expressed by Formula (6), the capacitor current reduction control can be performed using a correct current value, and the reliability of the operation for reducing the capacitor current is enhanced.

Note that in the present embodiment, the converter 120 is controlled such that the converter input current Iin includes the pulsation component of the fundamental wave frequency ωₘ of the pulsation of the load torque corresponding to the rotational speed fm of the motor 314. However, the converter 120 may be controlled such that the converter input current Iin also includes a pulsation component corresponding to an integral multiple of the fundamental wave frequency ωₘ. This can further reduce the capacitor current I3.

### Second Embodiment

A description will next be given of a power conversion device according to a second embodiment. The configuration of the power conversion device according to the second embodiment is similar to that of the power conversion device 1 according to the first embodiment except for an operation of the control unit 400 controlling the converter 120. In the present embodiment, a description will be given of a control operation for the converter 120, which is an operation different from that of the first embodiment.

In the power conversion device 1 according to the second embodiment, the control unit 400 controls the converter input current Iin so as to reduce the pulsation due to the AC power supply frequency fin, the pulsation being included in the converter input power Pin, thus reducing the capacitor current I3.

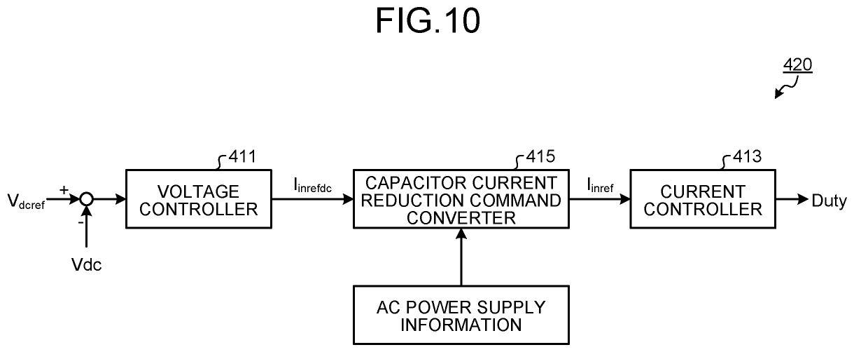

FIG. 10 is a diagram illustrating an example of a control block 420 constituting the control unit 400 of the power conversion device 1 according to the second embodiment. The control block 420 illustrated in FIG. 10 is provided to generate a control signal for the converter 120, and implements the capacitor current reduction control according to the second embodiment.

The control block 420 includes the voltage controller 411, a capacitor current reduction command converter 415, and the current controller 413. The voltage controller 411 and the current controller 413 of the control block 420 are the same as the voltage controller 411 and the current controller 413 of the control block 410 described in the first embodiment.

A description will be given of a method of deriving the converter input current command I_{inref} by the capacitor current reduction command converter 415. AC power supply information input to the capacitor current reduction command converter 415 can be, for example, the AC power supply frequency fin.

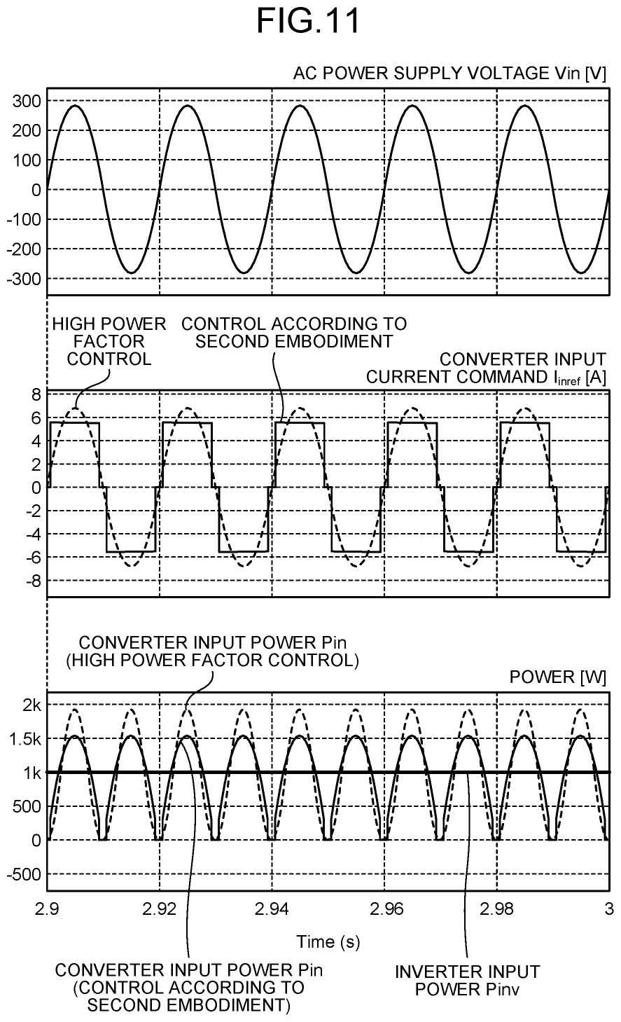

FIG. 11 is a diagram illustrating an example of operation waveforms of the power conversion device 1 according to the second embodiment. FIG. 11 illustrates an example of operation waveforms in the case where the power conversion device 1 drives the motor 314 of the compressor 315 using the general high power factor control, and in the case where the power conversion device 1 drives the motor 314 of the compressor 315 while controlling the converter 120 using the control to which the control block 420 illustrated in FIG. 10 is applied. In FIG. 11, the waveform at the upper section indicates the AC power supply voltage Vin. The two waveforms at the middle section indicate the converter input current command I_{inref}. A broken line indicates the converter input current command I_{inref} in performing the high power factor control. A solid line indicates the converter input current command I_{inref} in performing the control to which the control block 420 is applied. The three waveforms at the lower section indicate the converter input power Pin and the inverter input power Pinv. A broken line indicates the converter input power Pin in performing the high power factor control. A solid line indicates the converter input power Pin in performing the control to which the control block 420 is applied. In the operations corresponding to the operation waveforms illustrated in FIG. 11, the maximum value Vₛ of the AC power supply voltage Vin is 200√2 V, and the AC power supply frequency fin is 50 Hz. Additionally, only a DC component is used for the input power to the inverter 310 and is 1 kW.

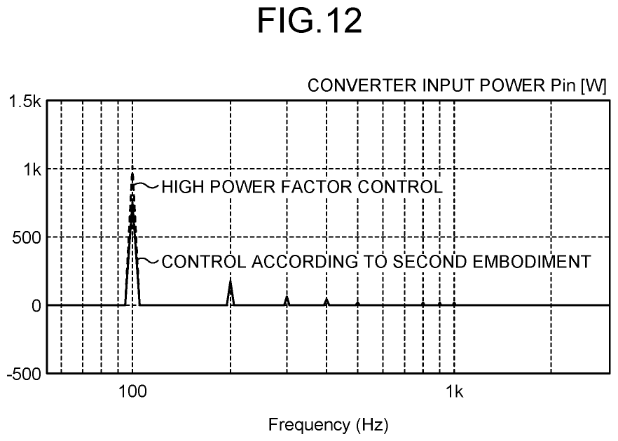

FIG. 12 is a diagram illustrating a frequency analysis result of the converter input power Pin illustrated in FIG. 11. A broken line indicates a frequency analysis result of the converter input power Pin in performing the high power factor control. A solid line indicates a frequency analysis result of the converter input power Pin in performing the control to which the control block 420 is applied.

It can be seen, from FIG. 12 and the second term on the right side of Formula (2) above, that the converter input power Pin pulsates at a frequency twice the AC power supply frequency fin (ωᵢₙ=50 Hz) in performing the high power factor control. In the following description, the frequency of such pulsation may be referred to as a second frequency. In the capacitor current reduction control according to the second embodiment, that is, the control to which the control block 420 is applied, the converter input current Iin is controlled so as to reduce the component included in the converter input power Pin and pulsating at the second frequency that is the frequency twice the AC power supply frequency fin.

Here, as an example of a control method of reducing, from the converter input power Pin, the component pulsating at the second frequency that is the frequency twice the AC power supply frequency fin, as illustrated at the middle section of FIG. 11, the capacitor current reduction command converter 415 outputs a rectangular-wave converter input current command I_{inref}. Note that, the converter input current command I_{inref} only needs to have a waveform that reduces the component pulsating at the second frequency, and, for example, may have a waveform of trapezoidal wave or such a waveform that the upper portion and the lower portion of the sine wave are clamped.

It can be seen from FIG. 11 that the pulsation of the converter input power Pin is reduced because of the rectangular-wave converter input current command I_{inref}. It can be seen, also from the frequency analysis result illustrated in FIG. 12, that the frequency component twice the AC power supply frequency fin is reduced.

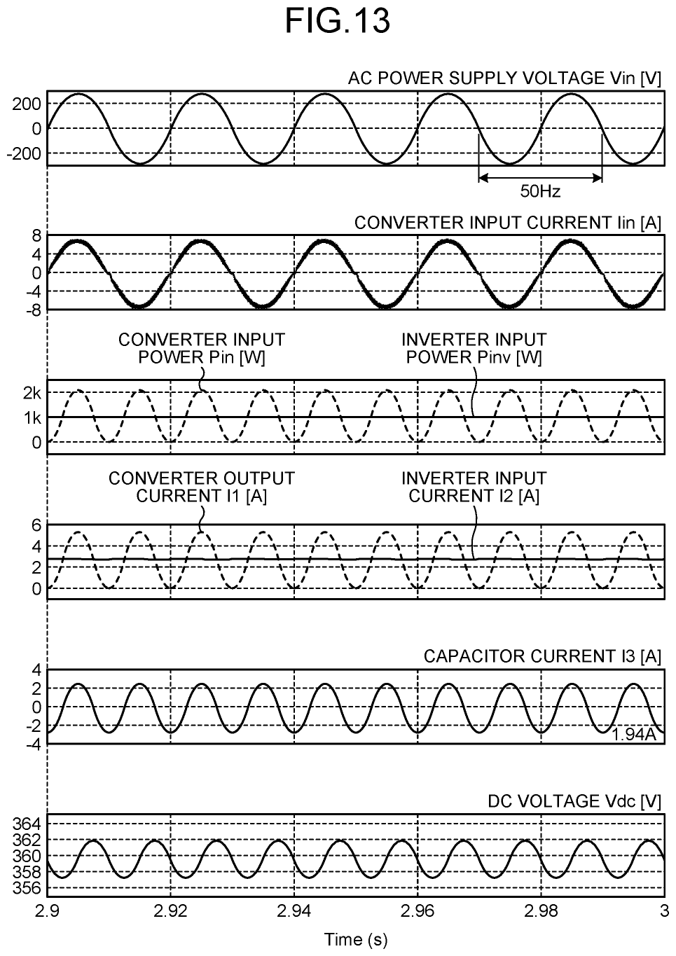

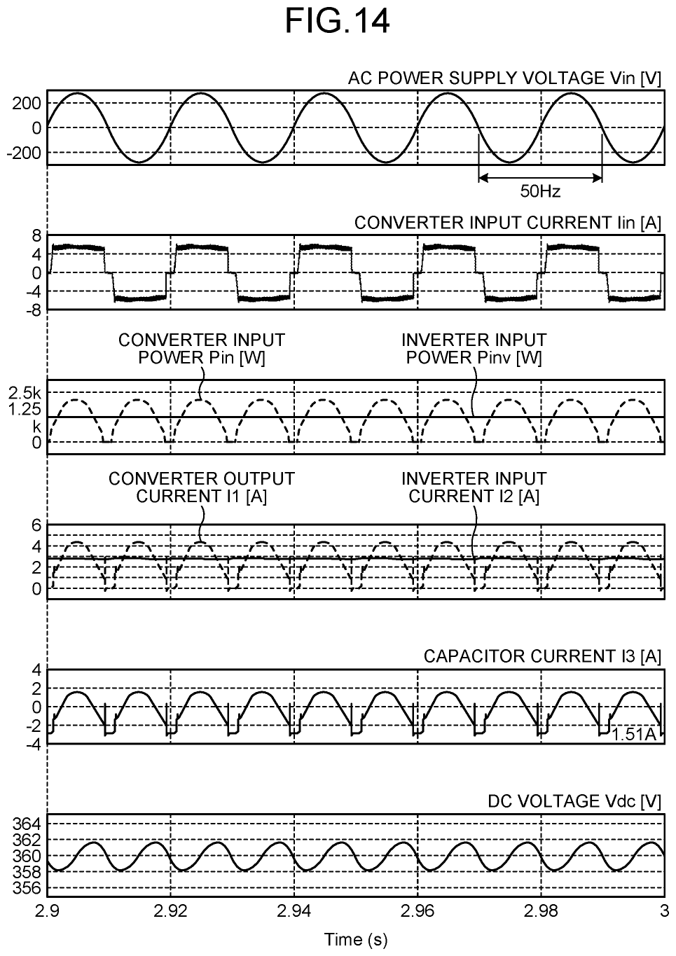

FIG. 13 is a diagram illustrating, as a comparative example, an example of operation waveforms (power waveform, current waveform, voltage waveform) of the respective constituent components in a case where the power conversion device 1 according to the second embodiment drives the motor 314 of the compressor 315 using the general high power factor control. Additionally, FIG. 14 is a diagram illustrating an example of operation waveforms (power waveform, current waveform, voltage waveform) of the respective constituent components in a case where the power conversion device 1 according to the second embodiment drives the motor 314 of the compressor 315 using the capacitor current reduction control (converter control implemented by applying the control block 420 in FIG. 10).

FIGS. 13 and 14 each illustrate the respective waveforms, in the order from top to bottom, of the AC power supply voltage Vin, the converter input current Iin, the converter input power Pin and the inverter input power Pinv, the converter output current I1 and the inverter input current I2, the capacitor current I3, and the DC voltage Vdc. The illustration of pulsations of the converter output current I1 and the capacitor current I3 due to the switching frequency is omitted. The inverter 310 and the motor 314 are simulated with a constant power load, and the load power is 1 kW. Additionally, the maximum value Vₛ of the AC power supply voltage Vin is 200√2 V, and the AC power supply frequency fin is 50 Hz. The DC voltage command V_{dcref} input to the control block 420 illustrated in FIG. 10 is 360 V.

By applying the capacitor current reduction control, according to the second embodiment, implemented by the control block 420 illustrated in FIG. 10, as illustrated in FIGS. 13 and 14, the capacitor current I3 is reduced from 1.94 A to 1.51 A as compared with the case where the capacitor current reduction control according to the second embodiment is not applied. Additionally, a ripple voltage of the DC voltage Vdc is also reduced.

As described above, the power conversion device 1 according to the second embodiment controls the converter input current Iin so as to reduce the component included in the converter input power Pin and pulsating at the second frequency due to the AC power supply frequency fin, thereby reducing the capacitor current I3 that is the current flowing to the smoothing capacitor 210 constituting the smoothing unit 200. The power conversion device 1 according to the second embodiment can reduce the current I3 flowing to the smoothing unit 200, and thus can have the same effects as those of the power conversion device 1 according to the first embodiment. That is, it is possible to use, as the smoothing capacitor 210, the capacitor having the lower ripple current tolerance, and to achieve cost reduction. Additionally, the pulsation voltage of the DC voltage Vdc decreases, thus making it possible to achieve a reduction in the capacitance of the smoothing capacitor 210 constituting the smoothing unit 200, that is, size reduction of the smoothing capacitor 210, and reduce the increase in size of the apparatus.

Note that in the second embodiment, the converter input current Iin is controlled so as to reduce the pulsation due to the AC power supply frequency fin. However, the converter 120 may be controlled so as to also reduce the pulsation due to a frequency that is an integral multiple of the AC power supply frequency fin. This can further reduce the capacitor current I3.

Additionally, in the second embodiment, the converter 120 is controlled using the control to reduce the increase in the capacitor current I3 due to the AC power supply frequency fin in the state where the vibration reduction control is not applied to the inverter 310. However, the control for the converter 120 described in the second embodiment may also be performed when the vibration reduction control is performed. That is, the control for the converter 120 described in the first embodiment and the control for the converter 120 described in the second embodiment may be performed. In the following description, for convenience, the control for the converter 120 described in the first embodiment may be referred to as first capacitor current reduction control, and the control for the converter 120 described in the second embodiment may be referred to as second capacitor current reduction control.

### Third Embodiment

A description will next be given of a power conversion device according to a third embodiment. The configuration of the power conversion device according to the third embodiment is similar to those of the power conversion devices 1 according to the first and second embodiments except for an operation of the control unit 400 controlling the converter 120 and the inverter 310. In the present embodiment, a description will be given of the operation of the control unit 400 controlling the converter 120 and the inverter 310. Note that, in the operation of the control unit 400, the description of the operation common to those in the first and second embodiments will be omitted.

In the first and second embodiments, the converter 120 is controlled, that is, the input current Iin to the converter 120 is controlled, thereby reducing the current flowing to the smoothing capacitor 210.

On the other hand, there is also a method of controlling the inverter 310 to reduce the current flowing to the smoothing capacitor 210. For example, in a case where the input current I2 to the inverter 310 is constant, the capacitor current I3 flowing to the smoothing capacitor 210 pulsates in accordance with a change in the converter input current Iin. In this case, the inverter 310 is controlled such that the inverter input current I2 pulsates in accordance with the change in the converter input current Iin, thereby reducing the pulsation of the capacitor current I3. As a result, the capacitor current I3 is reduced. However, there is a concern about an increase in heat generation of the semiconductor elements (switching elements 311a to 311f and freewheeling diodes 312a to 312f) constituting the inverter 310 since the pulsation of the inverter input current I2 causes an increase in the effective current value. In view of this, the pulsation of the inverter input current I2 is permitted only within a range in which the semiconductor elements are thermally established, and thus the effect of reducing the capacitor current I3 is limited.

Thus, in the power conversion device 1 according to the third embodiment, the operation of controlling the inverter 310 to reduce the capacitor current I3 and the operation of controlling the converter 120 to reduce the capacitor current I3 are performed in combination, thereby improving the effect of reducing the capacitor current I3. Note that in the following description, the control to operate the inverter 310 so as to reduce the capacitor current I3 is referred to as inverter current pulsation control.

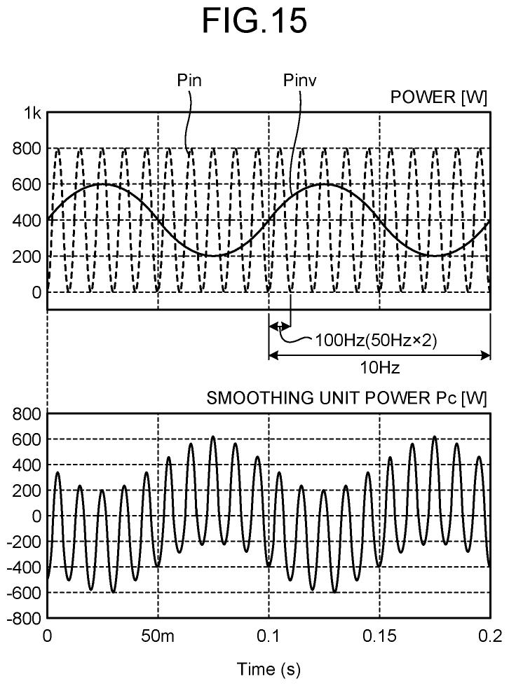

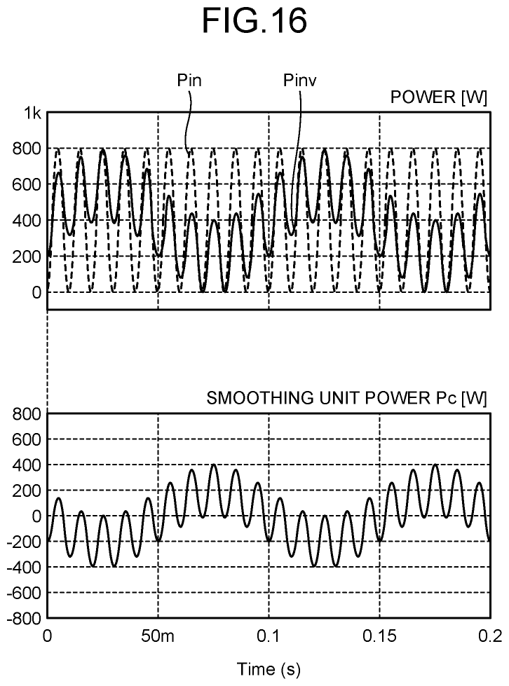

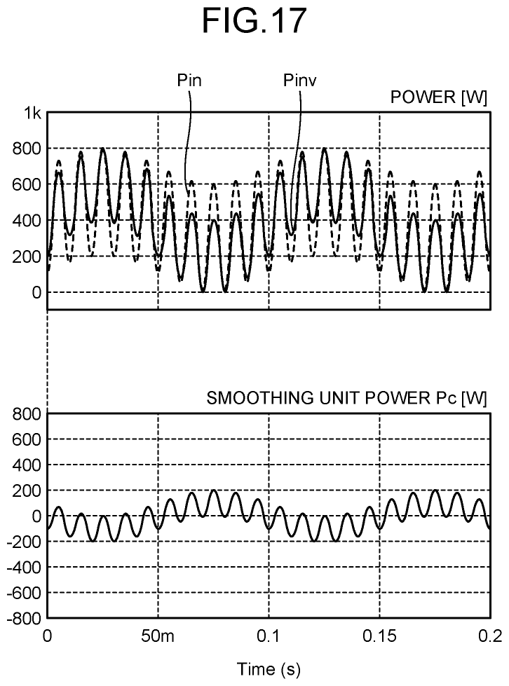

FIG. 15 is a diagram illustrating, as a first comparative example of the third embodiment, an example of operation waveforms in a case where the high power factor control and the vibration reduction control are performed in combination. FIG. 16 is a diagram illustrating, as a second comparative example of the third embodiment, an example of operation waveforms in a case where the high power factor control, the vibration reduction control, and the inverter current pulsation control are performed in combination. FIG. 17 is a diagram illustrating an example of operation waveforms in a case where the control according to the third embodiment is performed, specifically illustrating an example of operation waveforms in a case where the vibration reduction control, the inverter current pulsation control, and the capacitor current reduction control are performed in combination.

In each of FIGS. 15 to 17, waveforms at the upper section indicate the input power Pin to the converter 120 and the input power Pinv to the inverter 310, and a waveform at the lower section indicates power Pc of the smoothing unit 200.

In the operation corresponding to each of FIGS. 15 to 17, in consideration of the vibration reduction control, the inverter input power Pinv is given, in Formula (3) above, wherein P_{DC} is 400 W, Pₘ is 200 W, and the fundamental wave frequency ωₘ is 10 Hz. Additionally, the maximum value Vₛ of the voltage Vin of the AC power supply 110 is 200√2 V, and the frequency fin of the AC power supply 110 is 50 Hz.

The capacitor current reduction control applied to the operation corresponding to FIG. 17 is, as an example, the first capacitor current reduction control that is the control for the converter 120 described in the first embodiment. Note that, in a case where the capacitor current I3 flowing to the smoothing unit 200 has a pulsation that does not correspond to either the pulsation at the frequency due to the AC power supply frequency fin or the pulsation at the frequency due to the motor rotational speed, the pulsation component may be reduced by the control for the converter 120.

In the operation corresponding to FIG. 16, the performing of the inverter current pulsation control causes the pulsation of the inverter input power Pinv, thereby reducing the pulsating power included in the power Pc of the smoothing unit 200. The inverter current pulsation control causes the inverter input power Pinv to pulsate with the magnitude of a pulsation 0.5 times the pulsation component included in the converter input power Pin, that is, a power pulsation component due to the AC power supply frequency fin. Since the DC voltage Vdc is substantially constant, the pulsation waveform of the power Pc of the smoothing unit 200 and the waveform of the capacitor current I3 are similar to each other. Thus, it can be seen from FIG. 16 that the capacitor current I3 can be reduced by performing the high power factor control, the vibration reduction control, and the inverter current pulsation control in combination.

In the operation, according to the third embodiment, corresponding to FIG. 17, the performing of the first capacitor current reduction control achieves a reduction in the pulsation of the power of the smoothing unit 200 due to the vibration reduction control, and the performing of the inverter current pulsation control and the second capacitor current reduction control achieves a reduction in the pulsation of the power of the smoothing unit 200 due to the AC power supply frequency fin. Specifically, the first capacitor current reduction control causes the converter output current I1 to pulsate with the magnitude of a pulsation 0.5 times the pulsation due to the vibration reduction control, the inverter current pulsation control causes the inverter input current I2 to pulsate with the magnitude of a pulsation 0.5 times the pulsation due to the AC power supply frequency fin, and the second capacitor current reduction control causes the converter output current I1 to pulsate with the magnitude of a pulsation 0.25 times the pulsation due to the AC power supply frequency fin.

It can be seen from FIGS. 16 and 17 that the performing of the control according to the third embodiment can further reduce the pulsation of the power Pc of the smoothing unit 200 as compared with the performing of the control to obtain the operation waveforms of FIG. 16. Thus, it can be said that the effect of reducing the capacitor current I3 can be improved.

Note that, although both the first capacitor current reduction control and the second capacitor current reduction control are performed as the control according to the third embodiment, any one of the two capacitor current reduction controls may be performed as the control according to the third embodiment.

As described above, the power conversion device 1 according to the third embodiment performs the inverter current pulsation control to control the inverter 310 such that the inverter input current I2 pulsates in accordance with the change in the converter input current Iin and at least one of the first capacitor current reduction control described in the first embodiment or the second capacitor current reduction control described in the second embodiment, thereby causing the inverter input current I2 and the converter output current I1 to pulsate. Thus, the effect of reducing the capacitor current I3 can be improved more than that in the case where only the inverter current pulsation control is performed to reduce the capacitor current I3. Additionally, the effect of reducing the capacitor current I3 can be improved more than those in the first and second embodiments.

### Fourth Embodiment

A description will next be given of a power conversion device according to a fourth embodiment. The configuration of the power conversion device according to the fourth embodiment is similar to those of the power conversion devices 1 according to the first to third embodiments except for the operation of the control unit 400 controlling the converter 120. In the present embodiment, a description will be given of the operation of the control unit 400 controlling the converter 120. Note that, in the operation of the control unit 400, the description of the operation common to those in the first to third embodiments will be omitted.

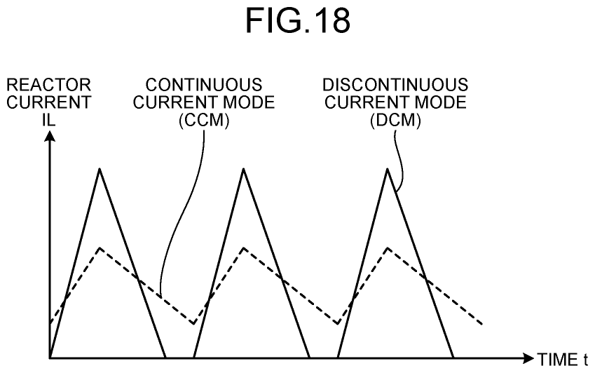

FIG. 18 is a diagram for describing an operation of the power conversion device 1 according to the fourth embodiment. In the first capacitor current reduction control described in the first embodiment and the second capacitor current reduction control described in the second embodiment, the converter 120 is operated in a Continuous Current Mode (CCM) in which a reactor current IL, which is a current flowing to the reactor 127 of the converter 120, has a waveform as indicated by a broken line in FIG. 18. On the other hand, in the power conversion device 1 according to the fourth embodiment, the converter 120 is operated in a Discontinuous Current Mode (DCM) in which the reactor current IL has a waveform as indicated by a solid line in FIG. 18. In the CCM operation, there is no period of time during which the reactor current IL is zero, and in the DCM operation, there is a period of time during which the reactor current IL is zero. That is, in the power conversion device 1 according to the fourth embodiment, the control unit 400 controls the converter 120 such that an interval of time occurs during which the reactor current IL is zero.

That is, the power conversion device 1 according to the fourth embodiment is configured such that the converter 120 is to be operated in the DCM operation in each of the power conversion devices 1 described in the first to third embodiments.

The control such that the converter 120 is to be in DCM achieves a reduction in inductance of the reactor 127 constituting the converter 120, and the size and cost reduction of the power conversion device 1.

### Fifth Embodiment

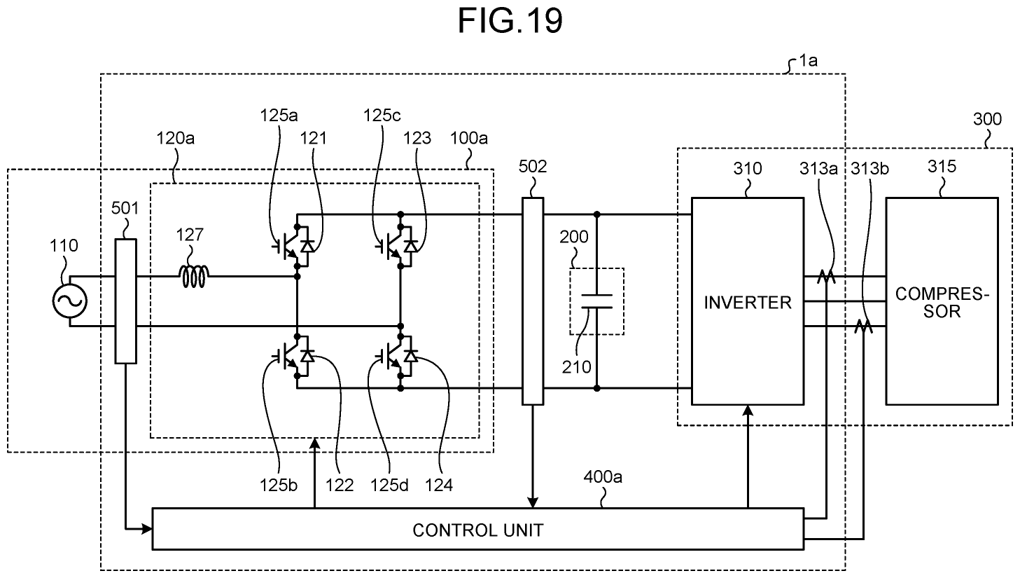

The power conversion device to which the capacitor current reduction control described in the first to fourth embodiments can be applied is not limited to the power conversion device 1 having the configuration illustrated in FIG. 2. For example, the capacitor current reduction control may be applied to a power conversion device having a configuration illustrated in each of FIGS. 19 to 21.

FIG. 19 is a diagram illustrating a first exemplary configuration of a power conversion device according to a fifth embodiment. A power conversion device 1a illustrated in FIG. 19 includes a converter 120a and a control unit 400a in place of the converter 120 and the control unit 400 of the power conversion device 1 illustrated in FIG. 2. Note that, the converter 120a constitutes a power supply unit 100a.

The converter 120a is a rectifier circuit having a Diode Bridge Less (DBL) configuration, and includes the reactor 127, switching elements 125a to 125d, and rectifiers 121 to 124 respectively connected in parallel with the switching elements 125a to 125d. The converter 120a turns on and off the switching elements 125a to 125d under the control of the control unit 400a, rectifies and boosts the first AC power supplied from the AC power supply 110, and outputs the boosted DC power to the smoothing unit 200. The converter 120a is controlled by the control unit 400a using full Pulse Amplitude Modulation (PAM) which allows the switching elements 125a to 125d to be switched continuously. The converter 120a performs power factor improvement control, thereby increasing the capacitor voltage Vdc of the smoothing capacitor 210 of the smoothing unit 200 to a voltage higher than the power supply voltage.

Since the other points of configuration are similar to that of the power conversion device 1 described above, the description thereof will be omitted.

The power conversion device 1a can achieve higher efficiency than the power conversion device 1 illustrated in FIG. 2.

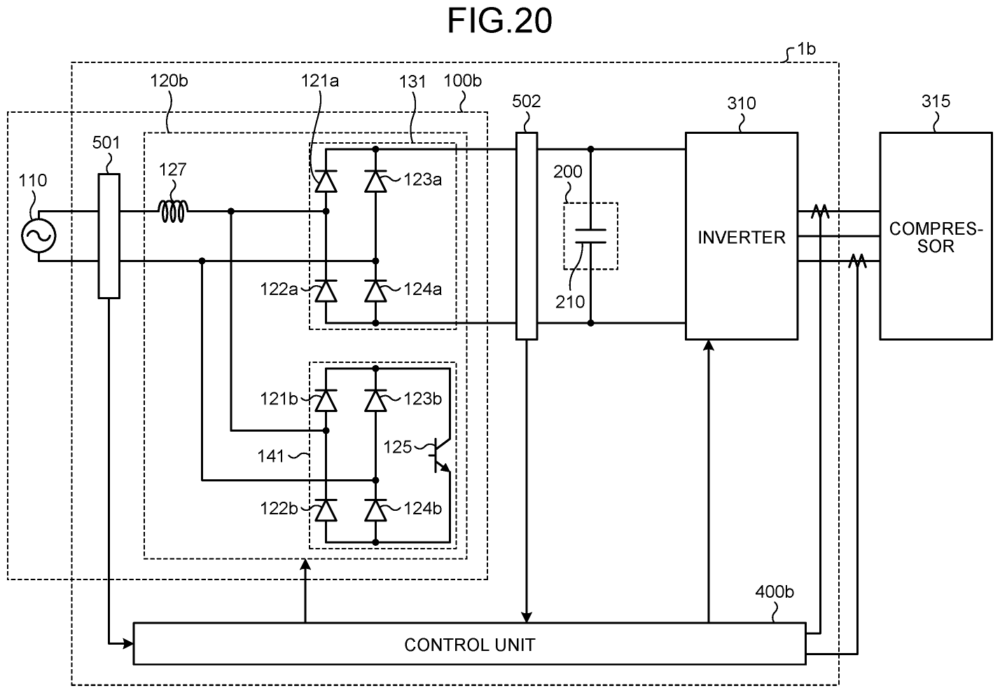

FIG. 20 is a diagram illustrating a second exemplary configuration of the power conversion device according to the fifth embodiment. A power conversion device 1b illustrated in FIG. 20 includes a converter 120b and a control unit 400b in place of the converter 120 and the control unit 400 of the power conversion device 1 illustrated in FIG. 2. Note that, the converter 120b constitutes a power supply unit 100b.

The converter 120b includes the reactor 127, a rectifier circuit 131, and a booster circuit 141. In the converter 120 constituting the power conversion device 1 illustrated in FIG. 2, the booster circuit 140 is connected in series at the subsequent stage of the rectifier circuit 130. On the other hand, in the converter 120b constituting the power conversion device 1b, the booster circuit 141 is connected in parallel with the rectifier circuit 131.

The rectifier circuit 131 of the converter 120b constituting the power conversion device 1b includes rectifiers 121a to 124a, and performs full-wave rectification of the first AC power supplied from the AC power supply 110. The rectifier circuit 131 is a circuit similar to the rectifier circuit 130 of the converter 120 constituting the power conversion device 1.

The booster circuit 141 includes rectifiers 121b to 124b and the switching element 125. The booster circuit 141 turns on and off the switching element 125 under the control of the control unit 400b, boosts the first AC power supplied from the AC power supply 110, and outputs the boosted power to the smoothing unit 200. The booster circuit 141 of the converter 120b is controlled by the control unit 400b using simplified switching in which the switching element 125 is switched one or more times in every half period of the frequency of the first AC power supplied from the AC power supply 110. The converter 120b performs the power factor improvement control, thereby increasing the capacitor voltage Vdc of the smoothing capacitor 210 of the smoothing unit 200 to a voltage higher than the power supply voltage.

Since the other points of configuration are similar to that of the power conversion device 1 described above, the description thereof will be omitted.

The power conversion device 1b can achieve higher efficiency than the power conversion device 1 illustrated in FIG. 2. The power conversion device 1b can also achieve noise reduction.

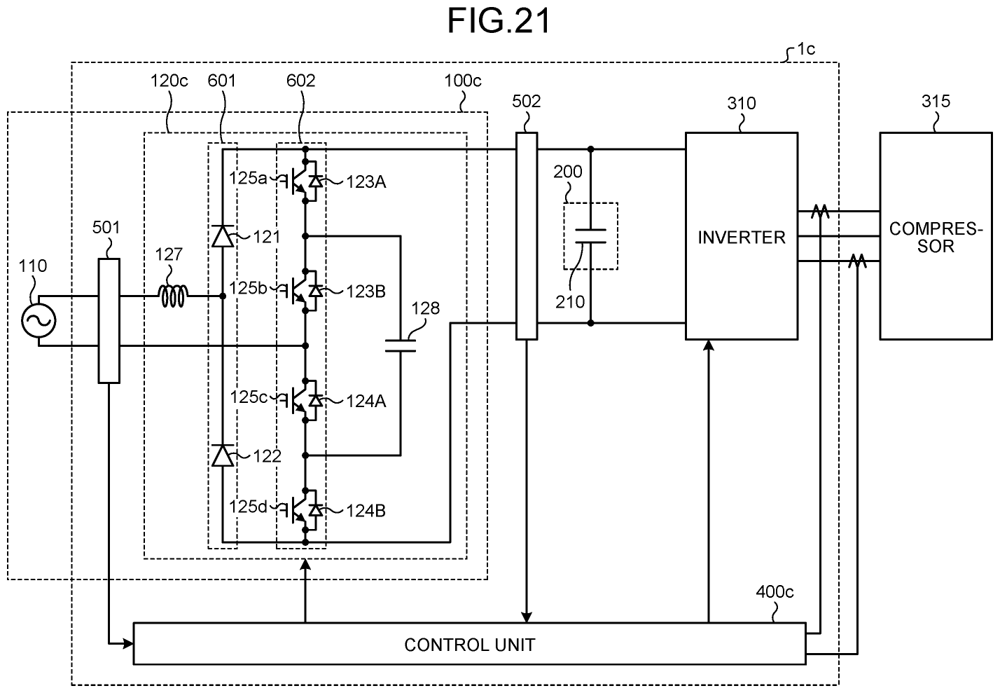

FIG. 21 is a diagram illustrating a third exemplary configuration of the power conversion device according to the fifth embodiment. A power conversion device 1c illustrated in FIG. 21 includes a converter 120c and a control unit 400c in place of the converter 120 and the control unit 400 of the power conversion device 1 illustrated in FIG. 2. Note that, the converter 120c constitutes a power supply unit 100c.

The converter 120c is a totem pole converter, and includes the reactor 127, the rectifiers 121 and 122, rectifiers 123A, 123B, 124A, and 124B, the switching elements 125a, 125b, 125c, and 125d, and a capacitor 128.

The reactor 127 limits an input current from the AC power supply 110. The rectifier 121 and the rectifier 122 are connected in series with each other to constitute a first series circuit 601 that is a rectifier bridge circuit that rectifies the AC power supplied from the AC power supply 110. A connection point between the rectifier 121 and the rectifier 122 is connected to one of output terminals of the AC power supply 110 via the reactor 127.

The four switching elements, that is, the switching elements 125a, 125b, 125c, and 125d are connected in series with each other, and constitute a second series circuit 602 together with the rectifiers 123A, 123B, 124A, and 124B each connected in parallel with a corresponding one of the four switching elements. The first series circuit 601 and the second series circuit 602 are connected in parallel with each other.

A connection point between the second switching element 125b and the third switching element 125c among the four switching elements constituting the second series circuit is connected to the other of the output terminals of the AC power supply 110. One end of the capacitor 128 is connected to a connection point between the first switching element 125a and the second switching element 125b among the four switching elements, and the other end of the capacitor 128 is connected to a connection point between the third switching element 125c and the fourth switching element 125d.

The converter 120c turns on and off the switching elements 125a to 125d under the control of the control unit 400c, rectifies and boosts the first AC power supplied from the AC power supply 110, and outputs the boosted DC power to the smoothing unit 200. The converter 120c performs the power factor improvement control, thereby increasing the capacitor voltage Vdc of the smoothing capacitor 210 of the smoothing unit 200 to a voltage higher than the power supply voltage.

Since the other points of configuration are similar to that of the power conversion device 1 described above, the description thereof will be omitted.

The power conversion device 1c can achieve higher efficiency than the power conversion device 1 illustrated in FIG. 2. The power conversion device 1c can also achieve a reduction in inductance.

A description will next be given of a hardware configuration of the control unit (control units 400, 400a, 400b, and 400c) included in the power conversion device (power conversion devices 1, 1a, 1b, and 1c) described in each of the embodiments. Note that, the hardware configurations of the control units are similar to one another.

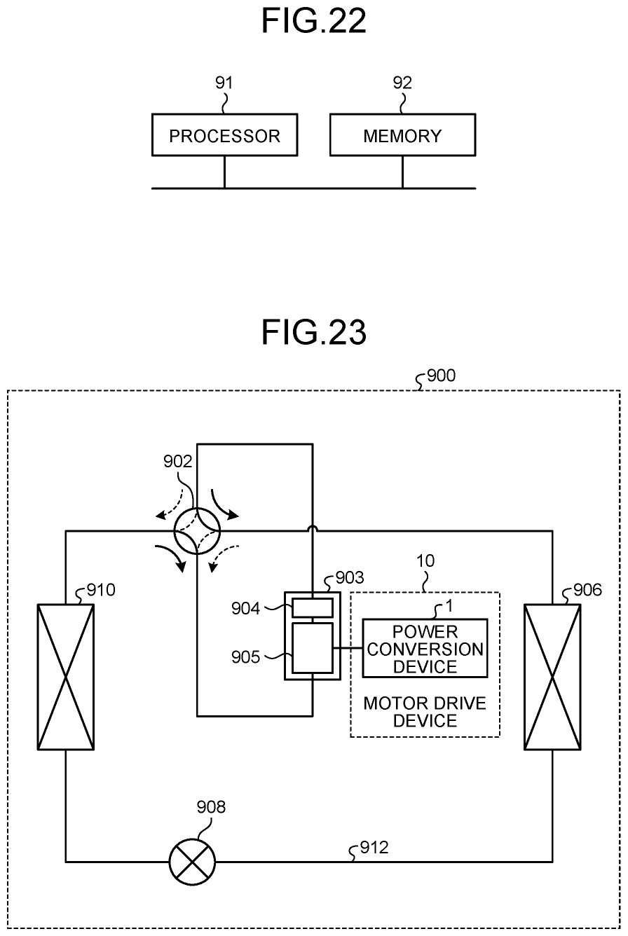

FIG. 22 is a diagram illustrating an example of the hardware configuration that implements the control unit included in the power conversion device. The control unit of the power conversion device is implemented by, for example, a processor 91 and a memory 92 illustrated in FIG. 22. The processor 91 is a Central Processing Unit (CPU) (also known as processing unit, computing unit, microprocessor, microcomputer, processor, and Digital Signal Processor (DSP)). The memory 92 is, for example, a Random Access Memory (RAM), a Read Only Memory (ROM), a flash memory, an Erasable Programmable Read Only Memory (EPROM), or an Electrically Erasable Programmable Read Only Memory (EEPROM; registered trademark).

The memory 92 stores a program for operation as the control unit of the power conversion device. The control unit of the power conversion device is implemented by the processor 91 reading and executing the program stored in the memory 92. For example, the program stored in the memory 92 may be provided to a user or the like by being stored in a storage medium such as a Compact Disc (CD)-ROM or a Digital Versatile Disc (DVD)-ROM, or may be provided via a network.

Note that, the control unit may also be implemented by a dedicated processing circuit such as a single circuit, a composite circuit, an Application Specific Integrated Circuit (ASIC), a Field Programmable Gate Array (FPGA), or a circuit obtained by combining these circuits.

### Sixth Embodiment

In the present embodiment, a description will be given of an apparatus that can be implemented by applying each of the power conversion devices described in the first to fifth embodiments. As an example, a description will be given of a refrigeration-cycle application apparatus including the power conversion device 1 described in the first embodiment.

FIG. 23 is a diagram illustrating an exemplary configuration of a refrigeration-cycle application apparatus 900 according to a sixth embodiment. The refrigeration-cycle application apparatus 900 according to the sixth embodiment includes the motor drive device 10 to which the power conversion device 1 described in the first embodiment is applied.

Additionally, the refrigeration-cycle application apparatus 900 includes a refrigeration cycle having a configuration in which a four-way valve 902, a compressor 903, a heat exchanger 906, an expansion valve 908, and a heat exchanger 910 are attached to each other via a refrigerant pipe 912. The compressor 903 corresponds to the compressor 315 illustrated in, for example, FIG. 2.

The compressor 903 includes a compression mechanism 904 that compresses a refrigerant circulating in the refrigerant pipe 912, and a motor 905 that operates the compression mechanism 904. The motor 905 corresponds to the motor 314 illustrated in FIG. 3.

For example, the refrigeration-cycle application apparatus 900 having such a configuration can be used for an air conditioner, a heat pump water heater, a refrigerator, a freezer, and the like.

The configurations described in the above embodiments are illustrative only and may be combined with the other known techniques, the embodiments may be combined with each other, and part of each of the configurations may be omitted or modified without departing from the gist.

1. A power conversion device comprising:
a converter rectifying a first alternating-current power supplied from an alternating-current power supply and boosting a voltage of the first alternating-current power rectified;
a smoothing unit connected to an output end of the converter; and
a control unit controlling the converter to cause an input current to the converter to change in accordance with a first frequency, and reducing a current flowing to the smoothing unit, the first frequency being a frequency of pulsation of input power to a load unit connected across the smoothing unit.

2. The power conversion device according to claim 1, wherein
the load unit includes an inverter converting power output from the converter and the smoothing unit into second AC power and outputting the second AC power to a motor, and
the control unit controls the converter to cause the input current to the converter to pulsate in accordance with a rotational speed of the motor.

3. The power conversion device according to claim 2, wherein
the control unit controls the converter to cause the input current to the converter to include a component that pulsates at a frequency same as the rotational speed of the motor.

4. The power conversion device according to claim 3, wherein
the control unit controls the converter to cause the input current to the converter to also include a component that pulsates at a frequency that is an integral multiple of the rotational speed of the motor.

5. The power conversion device according to claim 2, comprising a current sensor detecting the input current to the converter, wherein
the current sensor is capable of observing a current having a lower limit frequency less than a lower limit rotational speed of the motor.

6. The power conversion device according to claim 1, wherein
the control unit controls the converter to cause the input current to the converter to be changed so as to reduce a pulsation component due to the frequency of the alternating-current power supply, the pulsation component being included in the input power to the converter.

7. The power conversion device according to claim 6, wherein
the control unit controls the converter to cause a component of the input current to the converter having a frequency same as the frequency of the alternating-current power supply to be changed.

8. The power conversion device according to claim 7, wherein
the control unit controls the converter to cause a component of the input current to the converter having a frequency being an integral multiple of the frequency of the alternating-current power supply to be also changed.

9. The power conversion device according to claim 1, wherein
the control unit controls an inverter included in the load unit to cause an input current to the load unit to pulsate in accordance with a change in the input current to the converter.

10. The power conversion device according to claim 1, wherein
the control unit controls the converter to cause an interval of time to occur during which a current flowing to a reactor included in the converter is zero.

11. The power conversion device according to claim 1, wherein
the converter includes:
a rectifier circuit including a plurality of rectifiers; and
a booster circuit including a rectifier and a switching element whose on and off states are controlled by the control unit, and
the rectifier circuit and the booster circuit are connected in series or in parallel with each other.

12. The power conversion device according to claim 1, wherein
the converter includes:
a plurality of switching elements whose on and off states are controlled by the control unit; and
a plurality of rectifiers each connected in parallel with a corresponding one of the plurality of switching elements.

13. The power conversion device according to claim 1, wherein
the converter includes:
a first series circuit in which two rectifiers are connected in series with each other; and
a second series circuit including four switching elements connected in series with each other and four rectifiers each connected in parallel with a corresponding one of the four switching elements, the second series circuit being connected in parallel with the first series circuit.

14. A motor drive device comprising the power conversion device according to claim 1.

15. A refrigeration-cycle application apparatus comprising the power conversion device according to claim 1.

16. The power conversion device according to claim 1, wherein
the control unit controls the converter to cause the input current to the converter to change in accordance with the first frequency and a second frequency that is a frequency of pulsation of input power to the converter due to a frequency of the alternating-current power supply.
